(19) United States
(12) Patent Application Publication
(10) Pub. No.: US 2013/0013141 A1
(43) Pub. Date: Jan. 10, 2013

(54) MOTOR VEHICLE HYBRID DRIVE ARRANGEMENT

(76) Inventors: Konstantin Neiss, Esslingen (DE); Matthias Schlutter, Boblingen (DE); Ralf Körber, Stuttgart (DE); Jan Kipping, Stuttgart (DE)

(21) Appl. No.: 13/589,143

(22) Filed: Aug. 19, 2012

Related U.S. Application Data
(63) Continuation-in-part of application No. PCT/EP2010/007297, filed on Dec. 1, 2010.

(30) Foreign Application Priority Data
Mar. 4, 2010 (DE) 10 2010 010 149.4

(51) Int. Cl. B60W 20/00

(52) U.S. Cl. 701/22; 903/944; 180/65.29

(57) ABSTRACT

In a motor vehicle drive device, in particular a motor vehicle hybrid drive device, including an open-loop and/or closed-loop control unit, which is provided for controlling an energy store service unit for charging and/or discharging an energy store unit as a function of travel information items which are made available by a data assistance system, the control unit is adapted, in at least one operating state, to predictively calculate at least one state of charge (SOC) operating point of the energy store unit with an SOC derivative action as a function of the travel information items.

This is a Continuation-In-Part application of pending international patent application PCT/EP20101007297 filed Dec. 1, 2010 and claiming the priority of German patent application 10 2010 010 149.0 filed Mar. 4, 2010.

### BACKGROUND OF THE INVENTION

The invention relates to a motor vehicle drive arrangement, in particular a motor vehicle hybrid drive arrangement, with a control unit for controlling an energy store for maintaining energy store at an appropriate charge status depending on various driving an road conditions.

German Patent DE 10 2006 033 930 A1 already discloses a motor vehicle drive arrangement with an open-loop and/or closed-loop control unit, which is provided for controlling an energy store service unit for charging and/or discharging an energy store unit as a function of at least one distance-travelled information item which is made available by a data assistance system.

It is the principal object of the invention to increase driving comfort particularly in connection with a hybrid drive arrangement, to improve the hybrid drive experience for a driver and also the operating efficiency of hybrid drives by the controlled use of an electric driving mode.

### SUMMARY OF THE INVENTION

In a motor vehicle drive device, in particular a motor vehicle hybrid drive device, including an open-loop and/or closed-loop control unit, which is provided for controlling an energy store service unit for charging and/or discharging an energy store unit as a function of travel information items which are made available by a data assistance system, the control unit is adapted, in at least one operating state, to predictively calculate at least one state of charge (SOC) operating point of the energy store unit with an SOC derivative action as a function of the travel information items.

The open-loop and/or closed-loop control unit is provided for predictively calculating in at least one operating state, at least one SOC working point with an SOC derivative action as a function of the distance information item. As a result, a charge state of the energy store unit can be advantageously adapted to a route. By calculating SOC working points with an SOC derivative action, the motor vehicle drive device can react particularly advantageously to demands for drive torque, whereby in particular for a hybrid drive device, in this case an electric, driving mode can be used in defined driving situations. As a result driving comfort can be increased. Particularly in the case of a hybrid drive device hybrid experience can therefore be increased for a driver by controlled use of the electric driving mode. An“SOC” is in particular understood to mean the state of charge of the energy store unit. Preferably the SOC is indicated in percent, 0% corresponding to a fully discharged energy store unit and 100% to a fully charged energy store unit. An SOC working range of the energy store unit advantageously lies between 30% and 90%. An SOC normal value advantageously lies between 50% and 60%, 55% being especially advantageous. In this context an “SOC working value” is in particular understood to mean a target value for the SOC, which the open-loop and/or closed-loop control unit targets by means of the energy store service unit. The actual SOC is commensurate with the SOC working value, but basically can deviate from the actually predetermined SOC working value.

An “SOC derivative action” is also in particular understood to mean a value, which is added to the SOC normal value. An “SOC working value with an SOC derivative action” is therefore understood to mean in particular an SOC working value, which is increased in comparison to the SOC normal value. In particular this is understood to mean an SOC working value, which consists of the SOC normal value and the SOC derivative action. By “predictive calculation of the SOC working value with an SOC derivative action” it is understood to mean in particular that the open-loop and/or closed-loop control unit calculates an SOC working value with SOC derivative action, which is to be adjusted at a later point in time.

An energy store service unit is in particular understood to mean a unit, which is provided to supply energy in a defined way to the energy store unit or to remove energy in a defined way from the energy store unit. An “open-loop and/or closed-loop control unit” is understood to mean in particular a data processor with a memory and an operating program stored in the memory. “Provided” is understood to mean in particular especially programmed, equipped and/or designed.

Furthermore it proposed that the open-loop and/or closed-loop control unit be provided, in at least one operating state, for predictively calculating at least one SOC working point with an SOC potential as a function of the distance information item. As a result the motor vehicle power train system can also advantageously react to demands for brake torque, such as in particular through energy recuperation, whereby driving comfort can be further increased. An “SOC potential” is understood to mean in particular a value, which is deducted from the SOC normal value. An “SOC working value with an SOC potential” therefore is understood to mean in particular an SOC working value, which is lower in comparison to the SOC normal value. In particular it is understood to mean an SOC working value, which consists of the SOC normal value and the SOC potential. By “predictive calculation of the SOC working values with the SOC potential” it is understood to mean in particular that the open-loop and/or closed-loop control unit calculates an SOC working value with SOC potential, which is to be adjusted at a later point in time.

Basically the calculation of the SOC working points with an SOC potential is independent of the calculation of the SOC working points with an SOC derivative action. A motor vehicle drive device, in particular a motor vehicle hybrid drive device, having at least one data assistance system, which is provided for making available at least one distance-travelled information item, and an open-loop and/or closed-loop control unit, which is provided for controlling an energy store service unit for charging and/or discharging an energy store unit as a function of the distance information item, whereby the open-loop and/or closed-loop control unit, in at least one operating state, is provided for predictively calculating at least one SOC working point with an SOC potential as a function of the distance information item, can in principle be implemented independently of an inventive embodiment.

Furthermore it is proposed that the open-loop and/or closed-loop control unit is provided as distance information for considering at least one motor vehicle distance prognosis and/or one motor vehicle speed prognosis. As a result the various driving modes can be set particularly well-adapted to the route. Preferably the data assistance system makes available a large number of permanent route details, as for example information about road crossings, in particular urban road crossings with major importance and high traffic volumes, destinations, which for example were entered by a driver, speed restrictions, such as in particular 30 mph-limit zones, pedestrian precincts, play streets and/or residential side streets, as well as information about parking lots and/or multi-level car parks. In principle it is likewise conceivable that the data assistance system also makes available temporary route details as for example current traffic volume and/or traffic congestion.

In a particularly advantageous embodiment the open-loop and/or closed-loop control unit is provided fOr determining the at least one SOC working point as a function of at least one discrete distance-travelled event. As a result the open-loop and/or closed-loop control unit can determine the SOC working points particularly easily. “Discrete distance-travelled events” in this case are understood to mean in particular noteworthy positions along the route, which have a special importance especially in regard to setting defined SOC working points. They are understood to mean in particular a position for which subsequently a special driving mode, such as a purely electric driving mode or energy recuperation mode is particularly advantageous. The discrete distance-travelled event in this case can be determined by the open-loop and/or closed-loop control unit from the route information or made available by the data assistance system. By “function of the discrete distance-travelled event” it is understood to mean in particular that the SOC working point has a value which is adapted to the distance-travelled event, whereby the open-loop and/or closed-loop control unit is provided to ensure the SOC working point is adjusted when the distance-travelled event is reached.

In one refinement it is proposed that the open-loop and/or closed-loop control unit has at least one prognosis horizon and, within the prognosis horizon, is provided for determining different SOC working points for various distance-travelled events. As a result the SOC can be advantageously adapted to the different distance-travelled events within the prognosis horizon. Thus a particularly comfortable drive can be achieved.

In addition it is advantageous if the open-loop and/or closed-loop control unit is provided for weighting the various distance-travelled events and/or the different SOC working points. As a result the various distance-travelled events can be considered individually. For example a road crossing, where there is a low probability of stopping, can be considered in the calculation of a driving strategy differently than a traffic light, crossing, which has frequent red phases. “Weighting” in this case is understood to mean in particular information, which indicates the probability of occurrence and/or prioritization.

Preferably the prognosis horizon is speed-dependent. As a result the prognosis horizon can be adapted advantageously. Preferably the prognosis horizon is larger at high speeds than at low speeds.

The prognosis horizon can in particular also be dependent on the actual electric system consumer load. The electric system consumer load is understood to mean the load on the electric system, which is due to the different consumers in the electric system as for example seat heating, air conditioning etc. The higher the electric system consumer load, the smaller the prognosis horizon.

The prognosis horizon can in particular also be dependent on a distance to a road crossing with high turning probability from a most probable route. The prognosis horizon in this case is limited to the distance mentioned i.e. only distance-travelled events are considered which are located before the road crossing mentioned. The required information is made available by a data assistance system, which provides route details in the form of a motor vehicle distance prognosis. The motor vehicle distance prognosis describes the geometrical course of a journey, which is regarded by the data assistance system as the most probable route.

In addition it is proposed that the open-loop and/or closed-loop control unit is provided for limiting at least the SOC working point, with an SOC derivative action to a maximum value. As a result a reserve SOC potential may be created which can be kept free for energy recuperation. Preferably the SOC working point with an SOC derivative action is limited to 75%.

Besides, it is advantageous if the open-loop and/or closed-loop control unit is provided for making available a delta SOC signal dependent on the at least one SOC working point. As a result the delta SOC signal can be calculated particularly advantageously. A “delta SOC signal” is understood to mean in particular a parameter and/or a data value, which reflects a modification of the SOC. A delta SOC signal greater than zero advantageously corresponds to a charging process. A delta SOC signal smaller than zero preferably corresponds to a discharging process. The delta SOC signal can be formed for example as a CAN bus signal.

Additionally it is proposed that the open-loop and/or closed-loop control unit is provided for indirectly setting the at least one SOC working point. As a result the SOC working point advantageously can be set simply, “Indirect setting” in this case is understood to mean in particular that the open-loop and/or closed-loop control unit for setting the SOC working point specifies and/or regulates a characteristic, which influences the actual SOC. In particular it should be understood that direct regulation on the SOC working point is dispensed with. Preferably indirect setting takes place by means of load distribution within the motor vehicle power train system, whereby a load point shift of an electric motor is particularly advantageous for setting the SOC working point.

The invention will become more readily apparent from the following description of particular embodiments of the invention with reference to the accompanying drawings. The drawings, the description and the claims contain numerous features in combination. The person skilled in the art will also expediently consider the features individually and amalgamate them into practical further combinations.

### BRIEF DESCRIPTION OF THE DRAWINGS

FIG. 1 shows schematically a motor vehicle drive device formed as motor vehicle hybrid drive device,

FIG. 2 shows an elevation profile of an exemplary route,

FIG. 3 shows SOC potentials of SOC working points calculated along the route from FIG. 2,

FIG. 4 shows SOC derivative actions of SOC working points calculated along, the route from FIG. 2, and

FIG. 5 shows a delta SOC signal along the route from FIG. 2.

### DESCRIPTION OF PARTICULAR EMBODIMENTS OF THE INVENTION

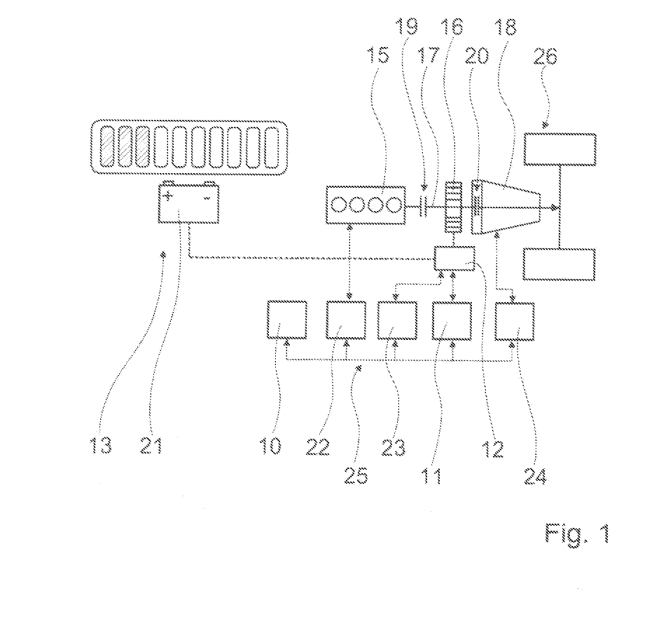

FIGS. 1-5 indicate an exemplary embodiment of an inventive motor vehicle drive device. The motor vehicle drive device is a motor vehicle hybrid drive device for a motor vehicle. The motor vehicle drive device comprises two power sources 15, 16 which are independent from each other. The first power source 15 is an internal combustion engine. The second power source 16 is an electric motor.

The motor vehicle drive device forms a parallel hybrid drive. The motor vehicle drive device comprises a drive shall 17, to which the two power sources 15, 16 are connected. For varying different transmission ratios the motor vehicle drive device comprises a gear unit 18. The gear unit 18 is arranged in a force flow behind the two power sources 15, 16. By means of the drive shaft 17 the power sources 15, 16 are operatively connected to the gear unit 18.

The drive shall 17 is of multi-part design. For connecting the first power source 15 the motor vehicle drive device comprises a first power shift clutch 19. The first power shift clutch 19 is arranged between the first power source 15 and the second power source 16. By means of the first power shift clutch 19 the two power sources 15, 16 can be mechanically connected together. For connecting the second power source 16 the rumor vehicle drive device comprises a power shift clutch 20. The second power shift clutch 20 is arranged between the second power source 16 and the gear unit 18. The two power shift clutches 19, 20 can be engaged independently.

The motor vehicle drive device also has an energy store unit 13 and an energy store service unit 12 connected to the energy store unit 13. The energy store service unit 12 is provided for charging and discharging the energy store unit 13. The energy store unit 13 comprises an accumulator 21, which can take up, store and release electric current. The energy store service unit 12 is designed as power electronics, by means of which a charging current and a discharging current can be adjusted for the energy store unit 13 in a defined manner.

The motor vehicle drive device also has an open-loop and/or closed-loop control unit 11. The open-loop and/or closed-loop control unit 11 is designed as a hybrid open-loop and/or closed-loop control unit, which in particular adjusts the interaction between the two power sources 15, 16. The open-loop and/or closed-loop control unit 11 is also provided for adjusting the energy store service unit 12. The open-loop and/or closed-loop control unit 11, as a function of an operating state, predetermines a defined charging current or discharging current, which is then adjusted by means of the energy store service unit 12.

Furthermore the open-loop and/or closed-loop control unit for the two power sources 15, 16 can predetermine a defined drive torque. The two power sources in each case comprise a drive controller 22, 23, which is provided for adjusting the corresponding power sources 15, 16. The gear unit 18 comprises a gear control device 24. The gear control device 24 is also provided for controlling the two power shift clutches 19, 20. The open-loop and/or closed-loop control unit 11, the two drive controllers 22, 23 and the gear control device 24 are connected together by means of a CAN bus system 25. They are intended to communicate between one another.

For charging the energy store unit 13 by means of the first power source 15 the open-loop and/or closed-loop control unit 11 engages the first power shift clutch 19, in addition it adjusts a charging current for the energy store service unit 12 greater than zero. The second power source 16 works as a generator, which converts mechanical power produced by the first power source 15 into electric power, which is then fed by means of the energy store service unit 12 to the energy store unit 13. For charging the energy store unit 13 by means of drive wheels 26, the open-loop and/or closed-loop control unit 11 engages the second power shift clutch 20 for example for a recuperation of brake energy. The first power shift clutch 19 in principle can be disengaged in this operating state.

If the motor vehicle is stationary or when the motor vehicle is coasting the open-loop and/or closed-loop control unit 11 disengages the first power shift clutch 19. The second power shift clutch 20 in principle can remain engaged if the motor vehicle is stationary or when the motor vehicle is coasting. In drive mode, during which a drive torque is greater than zero, the open-loop and/or closed-loop control unit 11 engages the second power shift clutch 20. In purely electric drive only the second power shift clutch 20 is engaged. The drive torque is produced in this operating state entirely by the second power source 16. In purely internal combustion engine drive mode the first power shift clutch 19 and the second power shift clutch 20 are engaged. The drive torque is produced in this drive mode entirely by the first power source 1.5. The second power source 16 in this case runs without load. In mixed drive mode likewise both power Shift clutches 19, 20 are engaged. The drive torque is then produced by the two power sources 15, 16 in parallel.

The open-loop and/or closed-loop control unit 11 automatically initiates load distribution of the drive torque. The open-loop and/or closed-loop control unit 11 stores characteristic data, which define the load distribution. In driving mode the drive torque is demanded by a driver. Using the characteristic data the open-loop and/or closed-loop control unit 11 then sets a drive torque for the power sources 15, 16 in each case. In essentially unaccelerated drive mode for example the open-loop and/or closed-loop control unit 11 can set a drive torque for the first power source 16, which is greater than the drive torque demanded by the driver, while it adjusts a charging current for the energy store service unit 12. The surplus drive torque of the first power source 15 is then used to charge the energy store unit 13. In starting mode for example the open-loop and/or closed-loop control unit 11 can firstly only engage the second power shift clutch 20, whereby the drive torque is firstly only produced by the second power source 16. The first power source 15, which can be switched off in the starting mode, can be started and then connected by engaging the first power shift clutch 19.

The SOC working range of the energy store unit 13 amounts to between 30% and 90%. The open-loop and/or closed-loop control unit 11 maintains the SOC of the energy store unit 13 in this SOC working range. An SOC normal value, which during the operation of the motor vehicle drive device is adjusted in the centre, amounts to approx. 55%. The actual SOC varies around this SOC normal value. Demand for additional drive torque, for example by the driver, causes the SOC to decrease. Energy recuperation for example demanded by the driver causes the SOC to increase.

The open-loop and/or closed-loop control unit 11 is provided for adjusting a charge state of the energy store unit 13. For adjusting the charge state, which is indicated, below with SOC, the open-loop and/or closed-loop control unit 11 determines a defined charging current or discharging current. The open-loop and/or closed-loop control unit 11 adjusts the charge state indirectly via the power distribution of the two power sources 15, 16. For charging the energy store unit 13 and thus tbr increasing the SOC the open-loop and/or closed-loop control unit 11 defines the power consumption for the second power source 16. For discharging the energy store unit 13 and thus for decreasing the SOC the open-loop and/or closed-loop control unit 11 defines the output of the second power source 16. The charging current or discharging current predetermined in this case by the open-loop and/or closed-loop control unit 11 is adjusted by means of the energy store service unit 12.

For controlling the energy store service unit the motor vehicle drive device 12 comprises a data assistance system 10, which makes available predictive route information The data assistance system 10 is connected by the CAN Bus system 25 to the open-loop and/or closed-loop control unit 11. The open-loop and/or closed loop control unit 11 cornmunicates with the data assistance system 10. It predictively controls the power sources 15, 16 and the energy store service unit 12 as a function of the route information made available by the data assistance system 10.

The open-loop and/or closed-loop control unit 11 predictively calculates SOC working points A₁, A₂, A₃, A₄, A₅, A₆ as a function of the route information of the data assistance system 10. The data assistance system 10 makes available, as route information, a motor vehicle distance prognosis and a motor vehicle speed prognosis. The motor vehicle distance prognosis describes the geometrical course of a route, which is assumed by the data assistance system 10 as the most probable route. The motor vehicle speed prognosis describes a vehicle speed, which is assumed for the motor vehicle on this route. The route information is transmitted by the data assistance system 10 in standardized format to the open-loop and/or closed-loop control unit 11.

The open-loop and/or closed-loop control unit 11 has a speed-dependent prognosis horizon 14, within which the open-loop and/or closed-loop control unit 11 determines the distance-travelled events i₁, i₂, i₃, i₄, i₅, i₆ from the route information made available by the data assistance system 10. In addition the prognosis horizon 14 depends on an actual electric system consumer load and on the distance from a road crossing with high probability of turning from a most probable route. The higher the electric system consumer load, the smaller the prognosis horizon 14. Before a road crossing with a high probability of turning, the prognosis horizon 14 is limited to the distance from the crossing mentioned.

The distance-traveled events have a weighting i₁, i₂, i₃, i₄, i₅, i₆, which is determined by the open-loop and/or closed-loop control unit 11 and used for calculating the SOC working points A₁, A₂, A₃, A₄, A₅, A₆. The weighting of the distance-travelled events i₁, i₂, i₃, i₄, i₅, i₆ depends on a probability of occurrence, in principle an additional continuing or an alternative weighting is also conceivable, if the open-loop and/or closed-loop control unit 11 within the prognosis horizon 14 detects several distance-travelled events i₁, i₂, i₃, i₄, i₅, i₆, which have a sufficient weighting, the open-loop and/or closed-loop control unit 11 defines the different SOC working points A₁, A₂, A₃, A₄, A₅, A₆ for these various distance-travelled events. The SOC working points A₁, A₂, A₃, A₄, A₅, A₆ have an SOC potential or an SOC derivative action as a function of the distance-travelled event.

The SOC working points A₄, A₆, have an SOC derivative action. The SOC working points A₁, A₂, A₃, A₄, A₅ have an SOC potential. The SOC working points A₄, A₆ with SOC derivative action are formed in comparison to the SOC normal value as increased SOC working points. The SOC working points A₁, A₂, A₃, A₅ with SOC potential are formed in comparison to the SOC normal value as lower SOC working point. The SOC working points A₁, A₂, A₃, A₄, A₅, A₆ are determined as a function of discrete distance-travelled events i₁, i₂, i₃, i₄, i₅, i₆. The discrete distance-travelled events i₁, i₂, i₃, i₄, i₅, i₆ are made available by the data assistance system 10.

The open-loop and/or closed-loop control unit 11 limits the SOC working points A₄, A₆ with an SOC derivative action, calculated thereby, to a maximum value, which lies within the SOC working range. The Maximum value is stored as a value in the open-loop and/or closed-loop control unit 11. It is fixed at 75%. The SOC derivative action, which is added to the SOC normal value, is thus limited to 20%. Regarding the SOC normal value, the open-loop and/or closed-loop control unit increases the SOC in the SOC working points A₄, A₆ with an SOC derivative action to a maximum of 75%.

For setting the SOC working points A₁, A₂, A₃, A₄, A₅, A₆ the open-loop and/or closed-loop control unit 11 makes available a delta DOC signal, which describes the charging current or discharging current to be adjusted. The delta DOC signal reflects a temporary modification of the SOC. If the delta SOC signal has a value greater than zero, the energy store service unit 12 adjusts the corresponding charging current. If the delta SOC signal has a value smaller than zero, the energy store service unit 12 adjusts the corresponding discharging current. The delta SOC signal is therefore proportional to a torque which is produced by the second power source as drive torque or brake torque.

The distance-traveled events i₁, i₂, i₃, i₄; i₅, i₆, are formed as discrete, that is to say geographically and temporally defined events. The data assistance system 10 stores permanent and temporary distance-travelled events i₁, i₂, i₃, i₄, i₅, i₆. As permanent distance-travelled events i₁, i₂, i₃, i₄, i₅, i₆ traffic lights, an elevation profile of the predicted route as well as permitted maximum speeds and information about road crossings are stored for example. As temporary distance-travelled events traffic congestion, traffic volume and road works are stored for example.

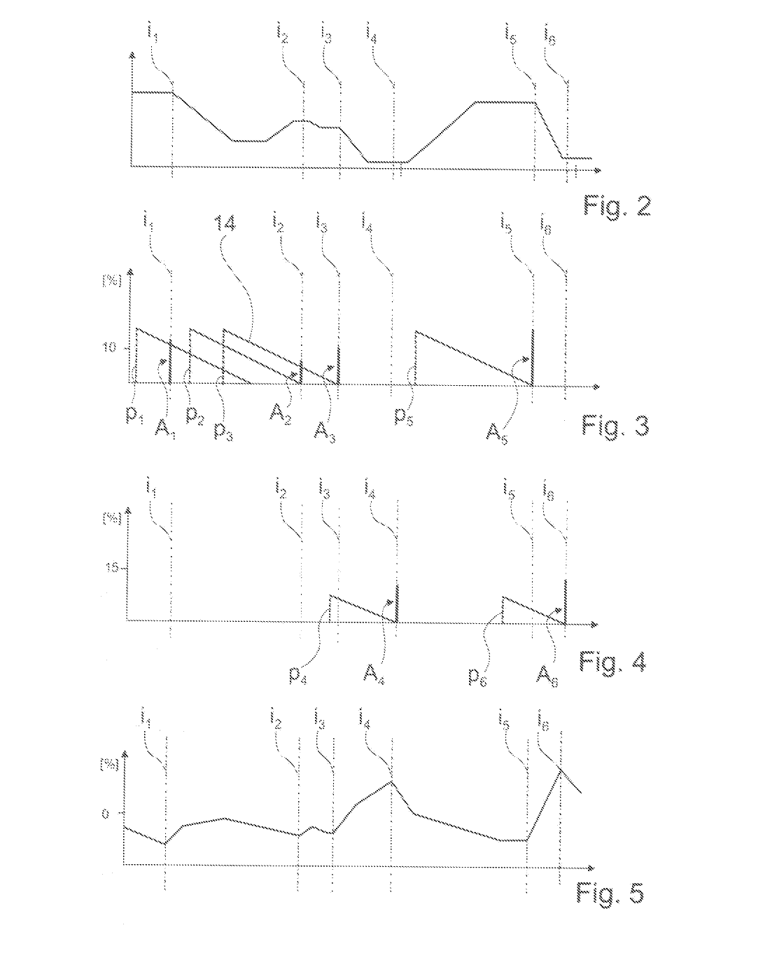

An exemplary route, which has an elevation profile made available by the data assistance system (cf. FIG. 2), includes a stop street as distance-travelled event i₄ and a 30 mph speed limit zone as distance-travelled event i₆. The position of the stop street and an area of the 30-limit zone are made available by the data assistance system 10. The open-loop and/or closed-loop control unit 11 in the elevation profile determines noteworthy points in the elevation profile, for which it calculates the SOC working points A₁, A₂, A₃, A₅ as distance-traveled events i₁, i₂, i₃, i₅. For the distance-travelled events i₄, i₆, which are formed as stop street or 30 mph limit zone, the open-loop and/or closed-loop control unit calculates the SOC working, points A₄, A₆.

The route starts at a position p₁. On the basis of the position p₁ the first distance-travelled event i₁, which the open-loop and/or closed-loop control unit 11 determines, lies in the prognosis horizon 14 of the open-loop and/or closed-loop control unit 11. The first distance-travelled event i₁ is formed as point of downhill gradient, at which the elevation profile changes from the flat to a downhill gradient. The SOC working point A₁ calculated for the distance-travelled event i₁ has an SOC potential, as the result of which braking energy is recuperated in the downhill gradient following the distance-travelled event i₁ and can be fed to the energy store unit 13 (cf. FIG. 3).

At a first position p₂ the open-loop and/or closed-loop control unit 11 detects the next discrete distance-travelled event i₂. The distance-travelled event i₂ is likewise formed as a point of downhill gradient. The SOC working point A₂, which the open-loop and/or closed-loop control unit 11 calculates for this distance-travelled event i₂, has an SOC potential (cf. FIG. 3). Since a downhill gradient following the distance-travelled event i₂ is less than the first downhill gradient, the SOC potential of the SOC working point A₂ is also lower than the SOC potential of the SOC working point A₁.

At a next position p₃, which again lies before a position belonging to the distance-travelled event i₂, the open-loop and/or closed-loop control unit 11 detects the third distance-travelled event h. Since the distance-travelled event i₃ is formed as a point of downhill gradient, the calculated SOC working point A₃ has an SOC potential. Because of the position p₂ both distance-travelled events i₂, i₃ fall within the prognosis horizon of the open-loop and/or closed-loop control unit 11 (cf. FIG. 3). The open-loop and/or closed-loop control unit 11 calculates its own SOC working point A₁, A₂, A₃, A₄, A₅, A₆, which is adapted to the corresponding distance-travelled event i₂, i₃ for each of the distance-travelled events i₂, i₃. Since the two downhill gradients, which follow the distance-travelled events i₂, i₃, are different, the SOC potentials of the SOC working points A₂, A₃, which at the same time lie within the prognosis horizon of the open-loop and/or closed-loop control unit, are also different.

At a position p₄ the open-loop and/or closed-loop control unit 11 detects the fourth distance-travelled event i₄, which is the stop street. For re-starting after the stop street the open-loop and/or closed-loop control unit 11 first selects the starting mode, in which the second power source 16 is used. The first power source 15 should only be switched on after accelerating. For electric starting the second power source 16 requires electric energy. The SOC working point A₄ calculated for the distance-travelled event i₄ thus has an SOC derivative action, as a result of which this additional electric energy is available at this position, which corresponds to the distance-travelled event i₄ (cf. FIG. 4).

The position p₄ again lies before a position belonging to the distance-travelled event i₃. At the position p₄ the open-loop and/or closed-loop control unit 11 therefore calculates the SOC working point A₃ with the SOC potential and the SOC working point A₄ with an SOC derivative action. The SOC working point A for the distance-travelled event is lower in comparison to the SOC normal value. The SOC working point A₄ for the distance-travelled event i₁ is increased in comparison to the SOC normal value. A path of the delta SOC signal directly before the distance-travelled event i₃ reflects the simultaneous consideration of both distance-travelled events i₃, i⁴ (cf. FIG. 5).

At a position p₅ the open-loop and/or closed-loop control unit 11 detects the fifth distance-travelled event i₅, which again describes a downhill gradient. By means of the distance-travelled event i₅ the open-loop and/or closed-loop control unit 11 recognizes that a high amount of recuperation energy can be obtained via the downhill gradient, which follows the distance-travelled event i₅. The SOC working point A₅ calculated for the distance-travelled event i₅ therefore has a correspondingly high SOC potential.

At a position p₆ the open-loop and/or closed-loop control unit 11 recognizes the sixth distance-travelled event i₆, which is the 30 mph speed limit zone. For driving through the 30 mph speed limit zone, which follows the distance-traveled event i₆, the open-loop and/or closed-loop control unit selects the electric, driving, mode. Accordingly the open-loop and/or closed-loop control unit 11 for the distance-traveled, information event i₆ calculates an SOC working point with an SOC derivative action V, which is sufficient for electric driving through the 30 mph speed limit zone.

The delta SOC signal calculates the open-loop and/or closed-loop control unit 11 as a function of the SOC working points A₁, A₂, A₃, A₄, A₅, A₆. For calculating the delta SOC signal the open-loop and/or closed-loop control unit 11 weights the SOC working points A₁, A₂, A₃, A₄, A₅, A₆ differently. At the position p₆ for example the open-loop and/or closed-loop control unit 11 considers the distance-travelled events i₅, i₆. At the position p₆ the following distance-travelled event i₅ is weighted higher than the distance travelled event i₆. Accordingly the delta SOC signal at first still remains negative. Only at a position, which corresponds to the distance-travelled event i₅, the delta SOC signal is increased in order to become positive during the downhill gradient following the distance-travelled event i₅.

What is claimed is:

1. A motor vehicle hybrid, drive arrangement including an energy store unit (13), an energy store service unit (12), at least one of an open-loop and a closed-loop control unit (11) for controlling the energy store service unit (12) for charging and discharging the energy store unit (13) as a function of at least one road travel information item, a data assistance system (10) connected to the energy store service unit (12) for supplying travel information to the data assistance system (10), wherein the open-loop and/or closed-loop control unit (11), in at least one operating state is provided for predictively calculating at least one state of charge (SOC) working point (A₄, A₆) with an SOC derivative action as a function of a road travel distance information item, the control unit (11) being provided for calculating the at least one SOC working point (A₄, A₆) as a function of at least one discrete travel event (i₄, i₆) in the form of a traffic light, a stop sign, or a road crossing.

2. The motor vehicle drive arrangement according to claim 1, wherein the control unit (11), in at least one operating state, is provided for predictively calculating at least one SOC working point (A₁, A₂, A₃, A₅) with an SOC potential as a function of the travel distance information item.

3. The motor vehicle drive device according to claim 2, wherein the control unit (11) is provided for considering as travel distance information at least one of a motor vehicle distance prognosis and a motor vehicle speed prognosis.

4. The motor vehicle drive device according to claim 2, wherein the control unit (11) is provided for determining the at least one SOC working point as a function of at least one discrete travel distance event (i₁, i₂, i₃, i₄, i₅, i₆).

5. The motor vehicle drive device according to claim 4, wherein the control unit (11) has at least one prognosis horizon (14) and is provided, for determining different SOC working points (A₁, A₂, A₃, A₄, A₅, A₆) for various travel distance events (i₁, i₂, i₃, i₄, i₅, i₆), within the prognosis horizon (14).

6. The motor vehicle drive device according to claim 5, wherein the control unit (11) is provided for weighting at least one of the various travel distance events (i₁, i₂, i₃, i₄, i₅, i₆) and the different SOC working points (A₁, A₂, A₃, A₄, A₅, A₆).

7. The motor vehicle drive device according to claim 5, wherein the prognosis horizon (14) is travel speed-dependent.

8. The motor vehicle drive device according to claim 1, wherein the control unit (11) is provided for limiting at least the SOC working point (A₄, A₆) with an SOC derivative action to a maximum value.

9. The motor vehicle drive device according to claim 1, wherein the control unit (11) is provided for making available a delta SOC signal dependent on the at least one SOC working point.

10. The motor vehicle drive device according to claim 1, wherein the control unit (11) is provided for indirectly setting the at least one SOC working point.

11. A method for operating a motor vehicle hybrid arrangement including an energy store unit (13), an energy store service unit (12), a data assistance system (11) and a control unit with at least one of an open-loop and a closed-loop for controlling the energy store service unit (12) for charging and discharging the energy store unit (13) as a function of at least one travel distance information item made available by the data assistance system (11), the method comprising the steps of predictively calculating in at least one operating state at least one state of charge (SOC) working point (A₄, A₆) of the energy store unit (13) with an SOC derivative action as a function of the distance information item and determining, via the control unit (11), the at least one SOC working point as a function of at least one discrete travel distance event (i₄, i₆), the discrete travel distance event (i₄, i₆) being in the form of a traffic light, a stop street or a road crossing.

12. The method according to claim 11, wherein the control unit determines predictively a desired SOC of the energy store unit (13) depending on a state of a predicted travel road.
